(19) United States
(12) Patent Application Publication
(10) Pub. No.: US 2002/0087833 A1
(43) Pub. Date: Jul. 4, 2002

(54) Method and apparatus for distributed processor dispersal logic

(76) Inventors: James S. Burns, Los Altos, CA (US); Kin-Kee Sit, Sunnyvale, CA (US); Sailesh Kottapalli, Milpitas, CA (US); Kenneth D. Shoemaker, Los Altos Hill, CA (US)

Correspondence Address: KENYON & KENYON, 1500 K STREET, N.W., SUITE 700, WASHINGTON, DC, 20005, US

(21) Appl. No.: 09/749,725

(22) Filed: Dec. 28, 2000

(51) Int. Cl. G06F 9/30

(52) U.S. Cl. 712/215

(57) ABSTRACT

A method and system provides for efficient dispersal of instructions to be executed by a processor using a distributed methodology of a centralized scheduling structure. The method and system include mapping instructions received from at least two instruction groups during a first stage followed by remapping, merging, and distributing instructions to a plurality of functional units during a second stage. The use of a first and second stage allowing an increased number of instructions to be executed by a processor operating at a given clock rate.

### BACKGROUND OF THE INVENTION

Field of the Invention

The present invention relates generally to a processor system architecture. It particularly relates to a method and apparatus for distributed dispersal of instructions to processor functional units using a multi-stage centralized structure.

### BACKGROUND

In current processors, two schemes are commonly used to disperse instructions to the pipelined functional units, namely a centralized or distributed dispersion methodology that is typically implemented using instruction windows. Instruction windows allow a processor scheduler to optimize the execution of instructions (commonly referred to as operations after decoding and translating) by issuing them to the appropriate functional units as the units are available and as various dependencies allow. The instruction window may provide a storage area for operations and results of functional units.

For a distributed scheme, the distributed instruction windows, commonly referred to as reservation stations or queues, are located with each functional unit and may differ in queue size (number of queue entries) from one another. As instructions are delivered directly to individual functional units via the associated reservation station, the distributed scheme allows for a faster processor clock and potentially less global routing if the instruction fetch rate is less than the instruction dispersal rate. However, even if the reservation stations are assigned the same number of queue entries, instructions may be executed at different rates due to data dependencies, different execution latencies, and different rates of execution for each reservation station. Traffic loading problems may occur at each individual reservation leading to an inefficient dispersal of instructions. Therefore, for a distributed scheme, it is difficult to achieve optimal instruction dispersal to functional units since each reservation station only has a small portion of the dispersal information.

For a centralized scheme, instructions are distributed from a single queue to available functional units having requirements satisfying the type of instruction to be delivered. The centralized scheme, containing all dispersal information for routing including data and execution dependencies, allows for better load balancing across functional units, but may increase global routing if the rate of dispersing instructions is higher than the rate of fetching instructions.

The instructions executed by the functional units may include a variety of different operations including, but not limited to memory load operations, memory store operations, integer register operations, floating-point register operations, and other operations. The functional (execution) units of the processor executing these instructions are commonly implemented as multi-stage pipelines where each stage in the pipeline typically requires one processor clock cycle. An exemplary six-stage pipeline may include the following stages: instruction fetching, instruction decoding, operation issuing, operation fetching, executing, and committing stages. During the usual course of operation, the processor will perform its processing steps (e.g., fetching, decoding, and executing of instructions) along the pipeline stages aligned with a clock cycle while operating at a particular clock rate (e.g., 1 GHz).

Therefore, for a processor including pipelined functional units, high performance of the pipelines is a significant design consideration. A very important element of the pipeline design is the amount and complexity of the dispersal logic required for efficient processor performance especially for dispersing a large number of instructions. Typically, good performance may be achieved by breaking up the pipeline into stages of equal duration. The greater number of stages in the pipeline means less work per stage, and less work per stage means fewer levels of logic per stage. Fewer levels of logic means a faster clock, and a faster clock means faster program execution, and therefore better processor performance. However, increasing the number of stages leads to higher delays for flushing and filling the pipeline.

For programs being executed by a processor, the program code typically includes a plurality of branches that affect program flow. Branch prediction logic is used to avoid any execution penalties resulting from negative changes in program flow. Therefore, to help solve pipeline flushing and filling delays, improved branch prediction may be used to reduce the occurrence of control flow mispredictions and simultaneous multi-threading may be used to reduce the mispredict penalty. Also, increasing the processor dispersal width also increases performance (greater program execution). Therefore, to enable a faster clock and greater program execution, there is a need to reduce the dispersal logic for a pipelined processor while still maintaining efficient timing (alignment) between stages of the pipeline.

### BRIEF DESCRIPTION OF THE DRAWINGS

FIG. 1 shows an exemplary processor system architecture in accordance with embodiments of the present invention.

FIG. 2 shows an exemplary flow diagram of an exemplary instruction dispersion methodology in accordance with embodiments of the present invention.

### DETAILED DESCRIPTION

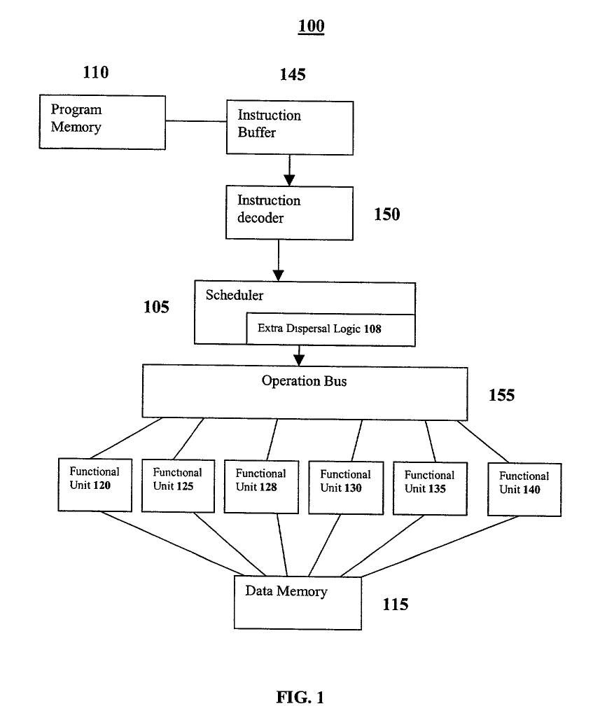

FIG. 1 shows an exemplary processor system architecture 100 in accordance with embodiments of the present invention. The intercoupled processor architecture includes a centralized scheduler 105, including extra dispersal logic 108, coupled to a plurality of functional units 120, 125, 128, 130, 135, 140 via an operation bus 155. Other intercoupled components of the architecture 100 include program memory 110, instruction buffer 145, instruction decoder 150, and data memory 115.

During operation, the processor system architecture 100 proceeds along the path of a multiple stage pipeline for fetching, decoding, and executing instructions while running programs. In the course of these stages, instructions are retrieved from program memory 110, and then forwarded to instruction buffer 145. Instruction decoder 150 decodes the instructions and forwards them to centralized scheduler 105. Centralized scheduler 105, based on the instruction type and individual functional unit requirements, maps the instructions to the one or more of the functional units 120, 125, 128, 130, 135, 140 and delivers the instructions to the functional units via operation bus 155 and using dispersal logic circuitry within centralized scheduler 105. The plurality of functional units 120, 125, 128, 130, 135, 140 may include a variety of different functional unit types including a store unit, load unit, integer register unit, and floating point unit. Advantageously, the scheduler 105 may be programmed to perform the functions required for mapping, merging, remapping, and delivering the instructions to available functional units 120-140.

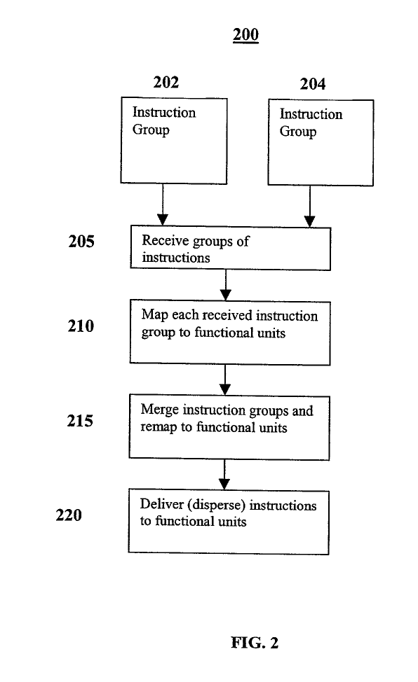

In accordance with embodiments of the present invention, scheduler 105 uses extra dispersal logic 108 to receive instructions from program memory 110 in at least two groups of instructions, independently map the instruction groups to functional units 120140 during a stage (e.g., a first stage) of the pipeline, merge the instruction groups and remap them to the functional units 120-140 during a subsequent stage (e.g., a second stage) of the pipeline, and then deliver them to the selected functional units. Although the terms “first stage” and “second stage” will be used to describe these succeeding stages of the processor pipeline where instruction dispersal occurs, it is noted that these stages are not necessarily the actual first and second stages of the processor pipeline, but simply refer to two succeeding stages that follow each other in accordance with embodiments of the present invention. This methodology followed by system architecture 100 is described in reference to FIG. 2.

FIG. 2 shows an exemplary flow diagram 200 of an exemplary instruction dispersion methodology followed by the processor system architecture 100 of FIG. 1 in accordance with embodiments of the present invention. Advantageously, at step 205, the scheduler 105 receives multiple (e.g., two) instruction groups 202, 204 from program memory 110 via instruction buffer 145 and instruction decoder 150. At step 210, each instruction group is independently mapped based on the instruction type and functional unit requirement (e.g., load or store instruction required), using extra dispersal logic 108, to at least one of the plurality of functional units 120-140 during a first stage (e.g., a stage of the processor pipeline followed by architecture 100). At step 215, using extra dispersal logic 108, the instruction groups are merged together, and then remapped to the plurality of functional units 120-140 during a second stage (e.g., a subsequent stage of the processor pipeline followed by architecture 100). Then, at step 220, the instructions are dispersed (delivered) by the scheduler to the functional units 120-140 based on the mapping performed in the previous steps. Advantageously, the first and second stages occur in timing alignment (synchronization) with the processor clock cycle therefore allowing the processor to maintain an efficient, fast clock rate. Also, the functional units are advantageously pipelined which makes the units available every clock cycle, regardless of whether an instruction is delivered (dispersed) to a functional unit.

In accordance with embodiments of the present invention, a variety of instruction group distributions may be encountered and dispersed by the scheduler 105 using the methodology as described in FIG. 2. During the initial mapping at step 210 during the first stage, the scheduler 105 maps each instruction group to functional units as if the other instruction groups do not exist. Effectively, the scheduler treats each instruction group as having full access and availability to the entire processor system architecture 100 (e.g., full availability of functional units 120-140) as during normal instruction dispersal techniques that do not receive multiple instruction groups. Subsequent merging and remapping of the instruction groups ensure that no resource conflict occurs for delivery to the functional units 120-140. The scheduler, based on information from the instruction groups (e.g., type) and the availability of mapped functional units, can advantageously deliver the right amount of instructions to available functional units for improved processor efficiency.

In an exemplary scenario, two instruction groups are received by the scheduler 105 where a first instruction group may include six instructions. Due to data dependencies (e.g., still waiting for result from previous instruction execution), only 3 of the instructions from this first instruction group are mapped to the functional units 120140 during a first stage. For this example, there are six functional units 120-140 which potentially leaves three functional units still available to execute instructions. The second group of instructions includes three instructions that have been mapped to functional units during the first stage. Therefore, assuming there's no resource conflict between the six functional units, the independent groups of three instructions may be easily merged together and remapped to all six functional units (during a second stage) so that full processor efficiency is achieved (full use of all available functional units) and the logic is decreased per stage since the scheduler 105 does not have to process (view) and map all instruction groups at once during a single stage which slows down the logic processing for the processor system architecture 100. The instructions are then delivered to the mapped functional units.

Another exemplary scenario is where two instruction groups are received by the scheduler 105 and three instructions from the first group and three instructions from the second group are mapped to the functional units during the first stage. During the second stage, the instructions are merged in the scheduler and three instructions are for floating point operations but only two floating point functional units are available. The scheduler then must discard one of the floating point instructions to avoid a conflict and ensure that the maximum number of available functional are being used for full processor instruction dispersion efficiency.

In another exemplary scenario, the first instruction group may have six instructions mapped to the exemplary six functional units leaving no functional units available for instructions mapped from the second instruction group. In this case, following merger of the instructions, only those six instructions mapped from the first instruction group are delivered to the functional units and the other instructions mapped from the second group (e.g., three) remain in the scheduler. Then, during a later stage, a third instruction group is retrieved and mapped by the scheduler to the functional units and merged with the previous group of three instructions from the second instruction group. Then, the six instructions (three each from the second and third instruction group) may be dispersed (delivered) to the available six functional units for improved dispersion efficiency.

Advantageously, the different instruction groups may be prioritized to allow efficient execution and also avoid livelock and deadlock conditions. Livelock may occur where one instruction group is waiting to proceed, but another group constantly has higher priority. In an exemplary scenario, two instruction groups (e.g., group 0, group 1) are vying for access to particular functional units. Due to traffic concerns, only one group may be dispersed to the functional units and the processor system only gives priority to group 0 to proceed. Therefore, group 1 is never selected for dispersal and only incoming group 0's (instruction groups) are allowed to proceed to functional units leaving group 1 in an indefinite waiting cycle. The present invention avoids this livelock condition by using rolling (round-robin) priority where if initially group 0 is given first priority, the next time group 1 is given priority, and so on. Therefore, one instruction group is never indefinitely waiting to proceed.

Deadlock occurs where both instruction groups stop indefinitely while waiting for the other group to proceed. This may occur when both instruction groups are waiting for results of previously executed instructions to proceed. For efficient operation in accordance with embodiments of the present invention, this condition may be avoided by checking data dependencies between pipeline stages. An exemplary scenario may occur where a series of add instructions are interrelated such that instruction 0 adds registers 0 and 1 and puts the answer in register 3, and instruction 1 adds register 3 and register 5. Therefore, the result of instruction 0 needs to known by instruction 1 to efficiently complete the operation. By checking this data dependency, the result can be forwarded to the instruction that needs it to avoid any deadlock condition from occurring. Alternatively, unsatisfied dependencies may either stall the pipeline temporarily or the dependent instructions may be squashed and reissued.

In accordance with embodiments of the present invention, the use of a multi-stage dispersion methodology reduces the dispersal logic (per stage) for the processor by creating minimal critical paths while also improving system clock rate performance. Instead of view all instructions at once, the scheduler 105 breaks down the instructions into two or more manageable instruction groups which reduces the dispersal logic per stage of the pipeline. Due to the reduced dispersal logic per stage, an increased number of instructions may be dispersed and executed while still maintaining a fast clock rate. Also, other advantages of embodiments of the present invention include better load balancing across the functional units, and a smaller physical layout (e.g., fewer physical circuit interconnections resulting from reduced logic per stage).

Advantageously, the present invention may be used with any pipelined processor. This includes, but is not limited to single-threaded processors, simultaneous multithreaded (SMT) processors, wide dispersal processors, superpipelined processors, reduced instruction set (RISC) processors, and other processors.

Additionally, embodiments of the present invention may include a machine-readable medium having stored thereon a plurality of executable instructions, the plurality of instructions including instructions to perform the method described herein to map, merge, and then remap at least two independent groups of instructions to functional units within a processor system.

Although the invention is primarily described herein using a “two-stage” example, it will be appreciated by those skilled in the art that modifications and changes may be made without departing from the spirit and scope of the present invention. As such, the method and apparatus described herein may be equally applied to any instruction dispersion methodology that adds an additional processing stage to increase the number of instructions that may be executed per stage.

What is claimed is:

1. A processor, comprising:
a plurality of pipelined functional units for executing instructions;
a scheduler, coupled to the plurality of functional units, programmed for independently mapping instructions, received from at least two separate instruction groups, to at least a portion of the functional units during a first stage;
wherein the scheduler is programmed to merge and remap the instructions to at least a portion of functional units, based on functional unit requirements and availability, during a second stage.

2. The processor of claim 1, wherein the scheduler is programmed to deliver the instructions to the portion of functional units following merging and remapping.

3. The processor of claim 1, wherein the scheduler, in alignment with a processor clock cycle, is programmed to map the instructions during a first stage of the pipeline for the functional units, and programmed to merge and remap the instructions during a second stage of the pipeline for the functional units.

4. The processor of claim 1, wherein the functional units execute an increased number of instructions operating at a given clock rate.

5. The processor of claim 1, wherein the instruction groups follow a simultaneous multi-threading structure.

6. The processor of claim 1, wherein the instruction groups are prioritized to prevent pipeline failures during execution of instructions.

7. A machine-readable medium having stored thereon a plurality of executable instructions, the plurality of instructions comprising instructions to:
map instructions, received from at least two separate, independent instruction groups, to at least a portion of a plurality of pipelined functional units during a first stage;
merge and remap the instructions to at least a portion of functional units, based on functional unit requirements and availability, during a second stage.

8. The medium of claim 7, wherein said instructions include instructions to deliver the instructions to the portion of functional units following merging and remapping.

9. The medium of claim 7, wherein said instructions include instructions to map the instructions during a first stage of the pipeline for the functional units, and to merge and remap the instructions during a second stage of the pipeline for the functional units wherein the first and second stage are in alignment with a processor clock cycle.

10. The medium of claim 7, wherein the instructions include instructions to execute an increased number of instructions at a given clock rate.

11. The medium of claim 7, wherein the instruction groups follow a simultaneous multi-threading structure.

12. The medium of claim 7, wherein the instruction groups are prioritized to prevent pipeline failures during execution of instructions.

13. A method for dispersing instructions to executed by a processor, comprising:
mapping instructions, received from at least two separate, independent instruction groups, to at least a portion of a plurality of pipelined functional units during a first stage; and
merging and remapping the instructions to at least a portion of functional units, based on functional unit requirements and availability, during a second stage.

14. The method of claim 13, further comprising:
delivering the instructions to the portion of functional units following merging and remapping.

15. The method of claim 13, wherein the step of merging and remapping includes merging and remapping the instructions to the portion of functional units to allow execution of an increased number of instructions at a given clock rate.

16. The method of claim 13, wherein the step of mapping includes mapping the instructions, in alignment with a processor clock cycle, during a first stage of the pipeline for the functional units, and merging and remapping the instructions, in alignment with the processor clock cycle, during a second stage of the pipeline for the functional units.

17. The method of claim 13, wherein the instruction groups follow a simultaneous multi-threading structure.

18. The medium of claim 13, wherein the instruction groups are prioritized to prevent pipeline failures during execution of instructions.
